(19) United States
(12) Patent Application Publication
(10) Pub. No.: US 2024/0394481 A1
(43) Pub. Date: Nov. 28, 2024

(54) Prompt Generation

(71) Applicant: Sage Global Services Limited, Newcastle upon Tyne (GB)

(72) Inventors: Jeremiah Edwards, Boulder, CO (US); Rohit Kumar, Acton, MA (US); Srijith Rajamohan, Crozet, VA (US); Yu-Cheng Tsai, Redmond, WA (US)

(73) Assignee: Sage Global Services Limited, Newcastle upon Tyne (GB)

(21) Appl. No.: 18/670,369

(22) Filed: May 21, 2024

Related U.S. Application Data
(60) Provisional application No. 63/468,129, filed on May 22, 2023.
(60) Provisional application No. 63/537,272, filed on Sep. 8, 2023.

(51) Int. Cl. G06F 40/35; G06F 40/186

(52) U.S. Cl. CPC G06F 40/35; G06F 40/186

(57) ABSTRACT

A system and computer implemented method for generating validated prompt-templates for generating prompts for instructing large language models (LLMs) to perform specific tasks. An initial prompt is generated instructing an LLM to produce a plurality of candidate prompt-templates. The initial prompt includes an input data type to be included with a prompt generated using a candidate prompt-template, and output data to be produced by an LLM that has processed a prompt generated using a candidate prompt-template. The initial prompt is passed through an LLM to generate candidate prompt-templates. Test prompts are generated, each constructed from a candidate prompt-templates using input data from a set of pre-labelled input data having items of input data and corresponding labels. Each test prompt is passed through a further LLM to generate an output. The output is assessed, and candidate-prompt-templates are selected for subsequent generation of prompts.

### Cross Reference to Related Applications

This application claims priority to and the benefit of U.S. Provisional Patent Application No. 63/468, 129,filed on May 22, 2023, entitled “GENERATIVE AI”, and U.S. Provisional Patent Application No. 63/537,272, filed on Sep. 8, 2023, and entitled “GENERATIVE AI”, the contents of each of which are incorporated herein by reference as though fully set forth herein.

### TECHNICAL FIELD

The present invention relates to generating prompts for use with Large Language Models.

### BACKGROUND

Recently, there have been significant advances in the field of artificial intelligence, in particular in so-called “generative AI” technologies. These advances, which centre around large language models (LLMs) such as “GPT4”, created by OpenAI, and “LLaMa”, created by Meta, have sparked widespread efforts across many sectors to take advantage of this technology.

An important, and often very useful feature of these LLM-based systems is that many have been configured so that they can be instructed to generate responses using natural language “prompts”. Such prompts can be used to generate a response to factual queries (e.g. “What is the capital of France?”) or instructions to perform a task (e.g. “Write an email inviting my friend to dinner”). Usefully, these systems can be used to generate a response based on some form of analysis of input data provided with the prompt itself, for example analysing a piece of text to identify a property of the text (e.g. “What sentiment is expressed in this email <text from email>”, or “Identify all the invoice numbers referenced in this email <text from email>”). This latter example is particularly useful in the field of automating information processing in business data systems.

However, a notable challenge that has emerged is creating an optimum prompt to get an LLM-based model to produce, as consistently as possible, the optimum output.

Large language models, operate using a complex network of numerical weights. An input prompt is first turned into numerical vectors. These vectors are then processed through a model's many layers, each performing calculations and altering these vectors based on the pre-learned weights. The output, whether it's a continuation of text or a specific response, is created from the results of these calculations. The output is typically generated token by token in a sequential manner. A token typically represents, for example, approximately 0.75 of an English word. The way that these tokens are generated is non-deterministic—i.e. the same input will yield different results. For example, decoding strategies, like top-k sampling and top-p sampling, determine how the output tokens are selected for output. These techniques are known to introduce randomness. Further factors, such as the use of GPUs and a training architecture known as a ‘mixture of experts,’ where different parts of the network specialize in different sub-tasks also contribute to non-deterministic outputs.

These factors, along with the sheer size of the networks, make deterministic predictions about how a specific input prompt will be processed, in effect, impossible. Consequently, it is hard, if not impossible, to predict in advance what particular prompt formulation will provide an optimal output.

Furthermore, LLM-based systems typically function “probabilistically,” meaning they generate responses based on a distribution of possibilities rather than deterministic rules. They gauge the likelihood of each potential response and then choose the one that, based on its training data and current algorithms, seems most probable. This element of statistical variation adds a further layer of unpredictability to their responses.

This probabilistic nature often leads to outputs that can diverge significantly even with minor alterations in the input prompt. In a practical context such as sentiment analysis of a text, the subtleties in phrasing or wording of prompts can lead to considerable variations in the output, despite having similar intended outcomes.

These factors give rise to the practice of “prompt engineering,” where a multitude of prompts are designed and tested to identify the most effective ones. However, prompt engineering, when performed manually, becomes a laborious task. It is particularly impractical when developing systems that require numerous optimised prompts to carry out a variety of tasks.

As it stands now, the only reliable way to determine the effectiveness of a prompt is through empirical testing. But this process is time-consuming and requires considerable resources. The involvement of humans in the testing process adds another layer of complication. It can introduce subjective bias and inconsistency, making the evaluation less reliable.

All these factors combined make the testing and optimisation of prompts in AI systems a resource-intensive and challenging task. It limits the scalability and efficiency of AI deployments, hindering their broader application across different sectors.

### SUMMARY

In accordance with a first aspect of the invention, there is provided a computer implemented method of generating validated prompt-templates for generating prompts for instructing large language models (LLMs) to perform specific tasks. The method comprises the steps of: generating an initial prompt instructing an LLM to produce a plurality of candidate prompt-templates for generating test prompts, said initial prompt defining: an input data type to be included with a prompt generated using a candidate prompt-template, and output data to be produced by an LLM that has processed a prompt generated using a candidate prompt-template; passing the initial prompt through an LLM to generate a plurality of candidate prompt-templates; generating a plurality of test prompts, each test prompt constructed from one of the candidate prompt-templates using input data from a set of pre-labelled input data comprising a plurality of items of input data and corresponding labels, passing each test prompt through a further LLM to generate an output; assessing the output data produced by each test prompt with respect to the corresponding label associated with input data with which the test prompt was passed through the further LLM, and selecting, based on the assessing, one or more of the candidate-prompt-templates for subsequent generation of prompts.

Optionally, the output data defined in the initial prompt comprises property data associated with a property of the input data defined in the initial prompt.

Optionally, the initial prompt further defines a constraint instruction to be applied by each test prompt which constrains the generated property data generated by each test prompt.

Optionally, the constraint instruction specifies a plurality of predetermined properties of which the output data must comprise one.

Optionally, the property is one of a qualitative property of the input data or a quantitative property of the input data.

Optionally, the input data type defined by the initial prompt is text data.

Optionally, the input data type defined by the initial prompt is unstructured text data from a received message.

Optionally, each label associated with each item of pre-labelled data specifies property data associated with a property of the item of pre-labelled data.

Optionally, the property data specified by each label associated with each item of pre-labelled data specifies one of a plurality of predetermined properties.

Optionally the method further comprises: generating the set of pre-labelled input data by: retrieving labelled data samples from a labelled data samples data store; retrieving unlabelled data from an unlabelled-data data store; labelling the unlabelled data using an AI process guided by the labelled data, generating labelled data, and storing the labelled data as pre-labelled input data for use in generating the test prompts.

Optionally, the AI process is one of a semi-supervised learning process, an active learning process or a clustering process.

In accordance with a second aspect of the invention, there is provided a system for generating validated prompt-templates for generating prompts for instructing large language models (LLMs) to perform specific tasks, said system comprising a prompt-template generation instruction module configured to generate an initial prompt instructing an LLM to produce a plurality of candidate prompt-templates for generating test prompts, said initial prompt defining: an input data type to be included with a prompt generated using a candidate prompt-template, and output data to be produced by an LLM that has processed a prompt generated using a candidate prompt-template, said prompt-template generation instruction module configured to communicate the initial prompt to a first LLM system to generate a plurality of candidate prompt-templates. The system further comprises a test prompt generation module configured to generate a plurality of test prompts, each test prompt constructed from one of the candidate prompt-templates generated by the prompt-template generation instruction module using input data from a set of pre-labelled input data comprising a plurality of items of input data and corresponding labels, said test prompt generation module configured to communicate each test prompt through a further LLM system to generate an output. The system further comprises a prompt-template assessment unit configured to assess the output data produced by each test prompt with respect to the corresponding label associated with input data with which the test prompt was passed through the further LLM, and select, based on the assessing, one or more of the candidate-prompt-templates for subsequent generation of prompts.

Optionally, the system further comprises an AI labelling unit configured to: retrieve labelled data samples from a labelled data samples data store, and retrieve unlabelled data from an unlabelled data data store. The AI labelling unit further configured to: label the unlabelled data using an AI process guided by the labelled data; generate labelled data and forward the label data for storage in a labelled data storage as pre-labelled input data. The test prompt generation module is configured to obtain the pre-labelled input data for generating the test prompts from the labelled data storage.

Optionally, the AI process is one of a semi-supervised learning process, an active learning process or a clustering process.

In accordance with a third aspect of the invention, there is provided a system for generating labelled data for use in a system according to the second aspect of the invention. The system comprises a labelling unit configured to: retrieve labelled data samples from a labelled data samples data store; retrieve unlabelled data from an unlabelled-data data store; label the unlabelled data using an AI process guided by the labelled data, thereby generating labelled data, and store the labelled data as pre-labelled input data for use in generating test prompts using candidate prompt-templates.

In accordance with a fourth aspect of the invention, there is provided a method for generating labelled data for use in a system according to the second aspect of the invention. The method comprises: retrieving labelled data samples from a labelled data samples data store; retrieving unlabelled data from an unlabelled-data data store; labelling the unlabelled data using an AI process guided by the labelled data, thereby generating labelled data, and storing the labelled data as pre-labelled input data for use in generating test prompts using candidate prompt-templates.

In accordance with a fifth aspect of the invention, there is provided a computer program providing instructions which when implemented on a computing device implements a method according to the first aspect of the invention or the fourth aspect of the invention.

In accordance with certain embodiments of the invention, a technique is provided which can readily generate validated prompts for instructing LLMs to perform specific tasks on input data. The technique comprises three stages. In the first stage, an initial prompt is passed to an LLM-based AI system instructing the LLM-based AI system to produce a plurality of candidate prompt-templates, where each candidate prompt template can be used to create prompts for achieving a particular task using an LLM. For example, the task could be to identify the intent conveyed in a passage of text and the input data type could be unstructured text data extracted from an email.

The initial prompt specifies the type of input data that will be included with each prompt generated from a candidate prompt template (e.g. unstructured text extracted from a message such as an email), and the output data to be produced by LLM-based AI system that has processed a prompt generated from a candidate prompt template, (e.g. text data classifying the “intent” associated with the message).

At a second stage, each candidate prompt template, thus generated, is tested. Specifically, each candidate prompt template is used to generate a plurality of test prompts. The input data used with each test prompt is taken from a repository in which is stored a plurality of “pre-labelled” items of input data. These are items of input data that are stored with some form of label data which corresponds to some property of the input data. For example, the data items may be fragments of text data, and the labels may correspond with the “intent” conveyed in the text data (for example “sending remittance data”; “querying invoice”; “explaining lack of payment”, etc).

At a third stage, the output data generated by each test prompt generated from each candidate prompt template is assessed and a selection of the candidate prompt template or templates that produce the optimum test prompts is then made. This assessment is done with respect to the label data of the pre-labelled input data. For example, the assessment can be on the basis of which test prompts produced output data (e.g. classified intent) which most closely matched that defined in the label data.

Advantageously, this technique can be largely or even completely automated, meaning that large sets of ‘validated’ prompts can be generated with little or no human intervention. This is particularly useful in settings such as enterprise-scale accounting systems where many workflows comprise of numerous, varied tasks. These include those related to accounts, accounts receivable, and accounts payable processes. It is critical that these processes are performed accurately and with minimal deviation from standard practice.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a simplified schematic diagram of a system for generating sets of prompt-templates which can be used for generating prompts for instructing LLMs to perform various tasks in accordance with certain embodiments of the invention;

FIG. 2 provides a diagram depicting an example of label data stored on a labelled data database in accordance with certain embodiments of the invention;

FIG. 3 provides a flow diagram depicting a process of generating prompt-templates for use in generating prompts for instructing LLMs in accordance with certain embodiments of the invention, and

FIG. 4 provides a simplified schematic diagram depicting an implementation of a system in accordance with an example of the present technique.

### DETAILED DESCRIPTION

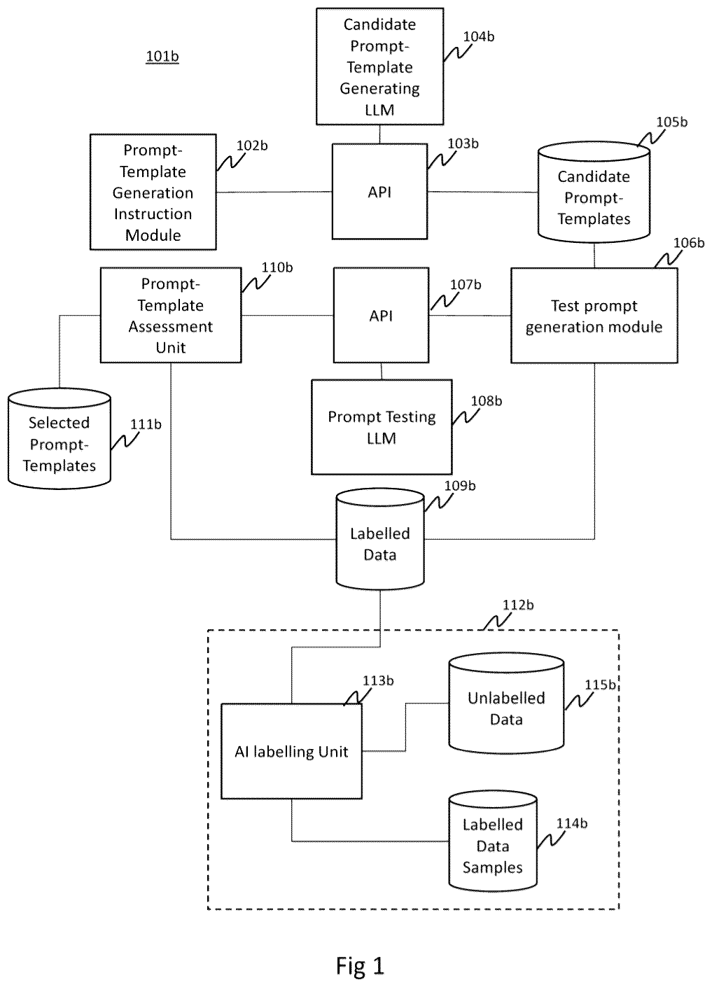

FIG. 1 provides a simplified schematic diagram of a prompt-template generating system 101b for efficiently generating, testing and validating prompt-templates which can then be used for generating prompts for instructing LLMs to perform various tasks. Such tasks include, for example, analysing unstructured input data (for example, data taken from the subject and/or bodies of received emails) to determine the “intent” of the messages in the emails.

The prompt-template generating system 101b includes a prompt-template generation instruction module 102b connected to a first LLM API 103b which is connected to a candidate prompt-template generating LLM 104b.

The first LLM API 103b is further connected to a candidate prompt-template database 105b which is connected to a test prompt generation module 106b. The test prompt generation module 106b is further connected to a second LLM API 107b which is connected to a prompt testing LLM 108b.

The test prompt generation module 106b is further connected to a labelled data database 109b. The labelled data database 109b and second LLM API 107b are further connected to a prompt assessment unit 110b.

In use, the prompt-template generation instruction module 102b is configured to generate an initial prompt-template-generation instruction prompt for the prompt-template generating LLM 104b, which instructs the prompt-template generating LLM 104b to generate a number of candidate prompt-templates. These candidate prompt-templates can then be used to generate a plurality of test prompts instructing an LLM-based AI system to perform a specific task.

This initial prompt defines at least the input data type which will be included with a test prompt generated in accordance with a candidate prompt-template, and the output data to be produced when a prompt generated in accordance with the candidate prompt-template is processed by an LLM.

Typically, the output data corresponds to a property inherent to the input data. This property can be qualitative, for example, where the input data is text data, a sentiment or ‘intent’ associated with text data. Alternatively, it can be quantitative, again for example, where the input data is text data, such as the presence or absence of a particular word, set of words, or specific reference, for example, an invoice number or a purchase order.

In certain examples, the initial prompt-template-generation instruction prompt further includes a constraint instruction to be applied when a prompt generated in accordance with the candidate prompt-template is processed by an LLM. Specifically, this constraint instruction imposes a constraint on the output data produced by the LLM. Typically, this constrains the generated property data generated by each test prompt. For example, as described in more detail below, in one example, the constraint instruction specifies a plurality of predetermined properties of which the output data must comprise one.

For example, the initial prompt-template-generation instruction prompt may include prompt text such as:
“generate ten different prompt-templates for generating prompts instructing an LLM to identify the intent of a received e-mail. Each prompt generated using the prompt-template must include unstructured input text from a received e-mail and the output produced by the prompt should comprise one of: “sending remittance data”; “querying invoice”; “explaining lack of payment” or “other””.

As can be understood, this initial prompt-template-generation instruction prompt defines:
1) An input data type that a prompt generated from a candidate prompt-template would include (i.e. the text from the prompt that specifies: “unstructured input text from a received e-mail”);
2) Output data to be produced when a prompt generated in accordance with the candidate prompt-template is processed by an LLM (i.e. the text from the prompt that specifies: “and the output produced by the prompt should comprise one of: “ . . . ””)
3) A constraint instruction (i.e. the text from the prompt that specifies that the output data must be one of: “sending remittance data”; “querying invoice”; “explaining lack of payment” or “other”)

The prompt-template generation instruction module 102b is configured to communicate the prompt-template-generation instruction prompt to the first LLM API 103b which forwards the prompt-template generation instruction prompt to the prompt-template generating LLM 104b.

The prompt-template-generation instruction prompt is then passed through the prompt-template generating LLM 104b which is then configured to generate the appropriate candidate prompt-templates which are communicated via the first LLM API 103b and stored in the candidate prompt-template database 105b.

Subsequently, the test prompt generation module 106b is configured to sequentially retrieve each candidate prompt-template from the candidate prompt-template database 105b and use them to construct (generate) various test prompts.

The input data for each test prompt is provided by data from the labelled data database 109b.

The labelled data database 109b has stored therein a plurality of data items, each linked to corresponding label data. The label data is indicative of a property of the data item with which it is linked.

In one example, the labelled data database 109b contains text data extracted from a multitude of emails. In this example, each data item comprise a fragment of email text and the label data linked to each data item specifies a property of the fragment of email text.

For example, the label data reflects the validated “intent” of the email message, which could be one of a predetermined plurality of validated intents such as ‘sending remittance data’, ‘querying invoice’, ‘explaining lack of payment’, or ‘other’.

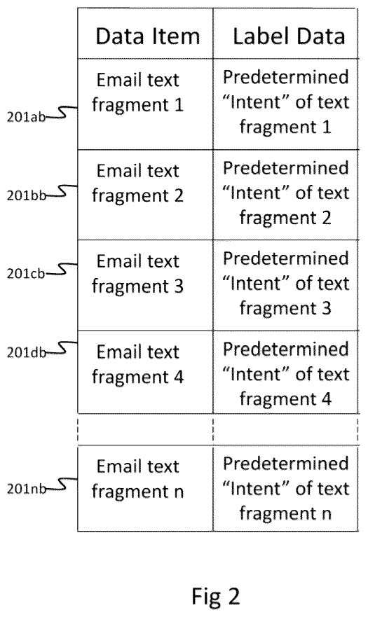

FIG. 2 provides a diagram depicting an example of the label data stored on the labelled data database 109b. As can be seen from FIG. 2, a data structure is provided which comprises a plurality of data records 201ab to 201nb, where each data record 201ab to 201nb comprises a data item provided by an e-mail text fragment, and corresponding label data providing a predetermined intent associated with the text fragment.

Thus, the labelled data stored in the labelled data database 109b comprises examples of input data to use with the test prompts which have also been “labelled” to indicate the ideal output the prompt should produce.

Each test prompt generated by the test prompt generation module 106b is passed to the second LLM API 107b which passes it to the prompt testing LLM 108b. The prompt testing LLM 108b then generates an output which is passed back via the second LLM API 107b to the prompt assessment unit 110b.

The prompt assessment unit 110b is configured to match the generated output from the prompt testing LLM 108b with the input data stored in the labelled data database 109b which was used to produce the test prompt and in particular, to compare the label data associated with the input data with the output generated by the prompt testing LLM 108b (step S304).

In this way, the prompt assessment unit 110b can assess and compare which different candidate prompt-templates produce test prompts which produce the most accurate output. Typically, this enables the prompt assessment unit 110b to select the one or more candidate prompt-templates that produce the optimum results, i.e. optimum test prompts.

Once the prompt assessment unit 110b has selected the one or more candidate prompt-templates that have produced the optimum test prompts, this candidate prompt-template, or these can candidate prompt-templates, are then stored in the selected prompt-template database 111b.

These prompt templates can then be used in the subsequent generation of prompts. For example, the prompt-templates can be retrieved from the by further systems, for example systems configured to automate the processing of received electronic communications, such as emails, relating to accounts-receivable and accounts-payable processing.

The prompt assessment unit 110b can operate in any suitable way. For example, in one embodiment, the prompt assessment unit 110b initiates a sequence of repeated tests for each generated test prompt from a specific candidate prompt-template. Each test prompt is applied not just multiple times, but also with different labelled input data from the labelled data database 109b. This approach is taken to ensure a sufficient volume of data is collected and that the testing covers a wide range of scenarios. It also helps mitigate the impact of any potential outliers.

Following this, the prompt assessment unit 110b systematically collates the resulting data. This collection includes the generated output, the expected output as per the labelled data, the specific candidate prompt-template used during the test, and other relevant data such as the time the test was conducted.

The prompt assessment unit 110b then employs predefined performance metrics to gauge the efficacy of each candidate prompt-template. These metrics might be as straightforward as simple “accuracy”, e.g., determining how often the AI-generated output matches the expected output. Alternatively, more complex metrics like precision, recall, or the F1 score can be used. In addition, similarity between the AI-generated outputs and the expected output as per the labelled data answers may be measured using a metric such as “Bert-score”. Furthermore, other LLMs may be employed to grade the similarity or match scores of the generated output to the expected output as per the labelled data.

Upon the application of these performance metrics, the prompt assessment unit 110b carries out an analysis, ranking the candidate prompt-templates based on their performance. This ranking process is based on the chosen performance metrics and could take into account a single metric or multiple performance indicators.

Upon completion of this analysis, the prompt assessment unit 110b identifies the optimal candidate prompt-templates. The selection process involves choosing either the top-performing candidate prompt-template or a selection of high-performing candidate prompt-templates. The selection depends on the goal, whether to adopt the best single approach or to incorporate a range of effective methods.

The labelled data stored in the labelled data database 109b can be generated in any suitable way.

For example, in certain examples the labelled data can be generated manually. This could involve human reviewers analysing the content of each email, understanding its intent or purpose, and assigning the appropriate label such as ‘sending remittance data’, ‘querying invoice’, ‘explaining lack of payment’, or ‘other’. Such reviewers may follow a set of guidelines to ensure consistency in labelling and to cover various edge cases.

However, in other examples, generation of the labelled data can be automated. This could involve the use of machine learning algorithms to analyse the content of the emails and predict their intent based on trained models, thus assigning the labels automatically. An example of this is depicted in FIG. 1.

FIG. 1 further depicts a labelled data generating system 112b for generating labelled data for use in the prompt-template generating system 101b. The system comprises an AI labelling unit 113b which is connected to a labelled data-samples database 114b and an unlabelled data database 115b.

In use, the AI labelling unit 113b is configured to retrieve samples of labelled data (for example e-mail text data with associated “intent” labels as described above) and use this data to automatically label unlabelled data retrieved from the unlabelled data database 115b.

The AI labelling unit 113b can use any suitable AI-based technique to do this, for example one or more of semi-supervised learning, active learning, clustering or an LLM-based technique. For instance, in a semi-supervised learning approach, the AI labelling unit 113b may use a limited amount of labelled data from the labelled data-samples database 114b in conjunction with a substantial volume of unlabelled data from the unlabelled data database 115b. By identifying and extrapolating the underlying structure in the labelled and unlabelled data, the AI labelling unit 113b can be configured to predict labels for the unlabelled data, thus effectively utilising available data resources even when labelled data is limited or expensive to acquire.

In an example using active learning, the AI labelling unit 113b can be configured to choose the most informative examples from the unlabelled data database 115b to be labelled. The choice of these samples could be based on a variety of strategies such as uncertainty sampling, where the data that the model is most uncertain about is selected, or query-by-committee, where the data about which a panel of models disagrees most is chosen. Once selected, these samples may be labelled manually or through another AI system.

In an example using a clustering-based approach, the AI labelling unit 113b may be configured to group similar unlabelled data points from the unlabelled data database 115b based on the similarity of their features. These groups, or clusters, can then be labelled collectively based on the common traits of the data points within each cluster. This could involve attributing the most common label in the labelled data-samples database 114b to all the data points in a cluster or employing other strategies to determine the most suitable label for each cluster.

In another example, the AI labelling unit 113b could use an LLM-based technique for generating labelled data. In this example, the AI labelling unit 113b may incorporate a specialised LLM which has been trained specifically for the task of generating the labelled data. In other examples, this may be a non-specialised LLM. The instruction passed to the LLM to label unlabelled data from the unlabelled data database 115b may include labelled data from the labelled data-samples database 114b to provide a suitable example.

The labelled data generated by the AI labelling unit 113b is forwarded to and stored in the labelled data database 109b.

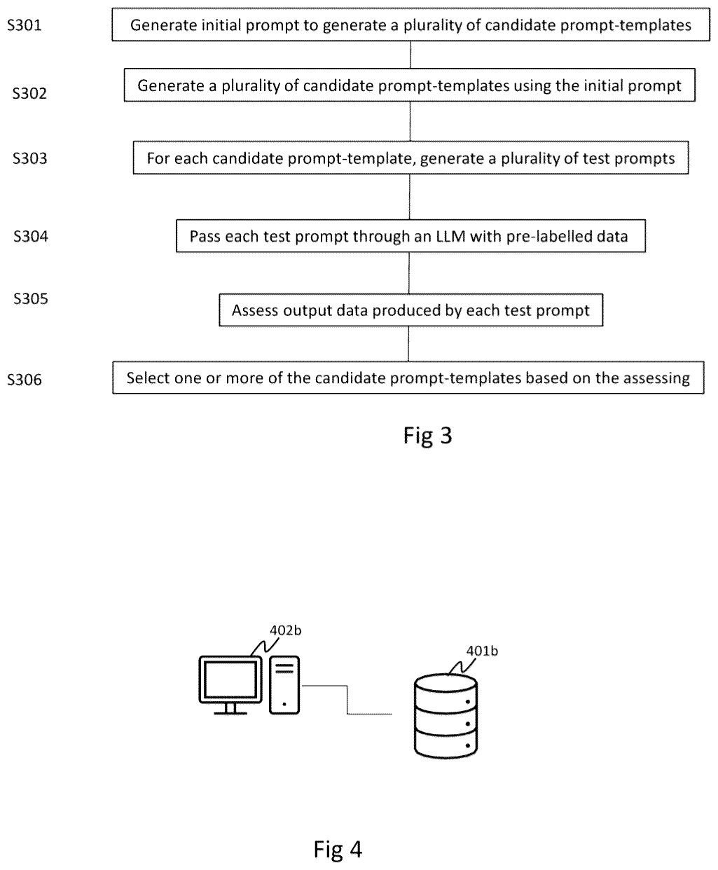

FIG. 3 provides a flow diagram depicting a computer implemented method for generating validated prompt-templates for generating prompts for instructing large language models (LLMs) to perform specific tasks in accordance with certain embodiments of the invention.

At a first step S301, an initial prompt is generated for instructing an LLM to produce a plurality of candidate prompt-templates for generating test prompts. As described above, the initial prompt defines an input data type to be included with a prompt generated using a candidate prompt-template; and output data to be produced by an LLM that has processed a prompt generated using a candidate prompt-template.

At a second step S302, this initial prompt is passed through an LLM to generate a plurality of candidate prompt-templates.

At a third step S303, for each candidate prompt-template, a plurality of test prompts is generated. Each test prompt is constructed from one of the candidate prompt-templates using input data from a set of pre-labelled input data. This pre-labelled input data comprises a plurality of items of input data and corresponding labels.

At a fourth step S304, each test prompt is passed through a further LLM to generate output data.

At a fifth step S305, the output data produced by each test prompt is assessed with respect to the corresponding label associated with input data with which the test prompt was passed through the further LLM.

At a sixth step S306, one or more of the candidate prompt-templates is selected based on the assessing performed during the fifth step S305.

Returning to FIG. 1, the skilled person will understand that the various components of the prompt-template generating system 101b, including the prompt-template generation instruction module 102b, first LLM API first LLM API 103b, prompt-template generating LLM 104b, test prompt generation module 106b, second LLM API 107b, prompt testing LLM 108b and prompt assessment unit 110b, and the AI labelling unit 113b in the labelled data generating system 112b can be implemented in any suitable way.

The skilled person will understand that these components can be implemented as a single application or in various other ways, such as separate modules, combined modules, distributed services, or in any other suitable configuration.

The components shown in FIG. 1, whether implemented as a single application or otherwise, can run locally or remotely on a single physical server or be distributed across servers using cloud computing. Furthermore, the components shown in FIG. 1, whether implemented as a single application or otherwise, can be carried out in any suitable environment, such as a ‘serverless’ environment, a traditional on-premises server, a virtual machine, a containerised environment (such as Docker), a Platform-as-a-Service (PaaS) environment, a fully managed cloud service, or any other appropriate environment that meets the system's requirements.

FIG. 4 provides a simplified schematic diagram depicting an implementation of a system in accordance with an example of the present technique. In this example, the prompt-template generating system 101b and the labelled data generating system 112b are implemented as a single application on an application server 401b and accessible via a terminal 402b connected to the application server 401b. The terminal 402b provides a means by which an operative can oversee operation of the prompt-template generating system 101b and labelled data generating system 112b.

The skilled person will understand that the prompt-template generating LLM 104b and prompt testing LLM 108b are abstractions representing complex data processing functionalities for implementing Large Language Models. These include data processing functionalities for receiving human-readable prompts and converting them through tokenisation into a numerical format suitable for a neural network. These further include data processing functionalities for passing the input through a network's layers, involving, for example, various mechanisms like attention and activation functions, based on the specific architectural configuration. These further include data processing functionalities for interpreting the output and decoding it back into a human-readable form, including components for preprocessing and postprocessing. The prompt-template generating LLM 104b can be implemented using conventional, generally trained LLMs or may be specifically trained to generate candidate prompt-templates. Similarly, the prompt testing LLM 108b can be configured and trained to model the LLMs on which selected prompts will be used for a given application.

Although shown as separate entities in the example depicted in FIG. 1, in certain examples, the functions of the prompt-template generating LLM 104b and the prompt testing LLM 108b may be consolidated into a single LLM. In such an example, this single LLM would be typically accessed via a single API, simplifying the architecture of the prompt-template generating system 101b.

The prompt-template generating LLM 104b and prompt testing LLM 108b can be integrated into the prompt-template generating system 101b as depicted in FIG. 1. However, in other examples, the prompt-template generating LLM 104b and prompt testing LLM 108b (or single LLM if implemented as a consolidated LLM) can be provided by a third party provider and accessed by the prompt-template generating system 101b via, for example, a data network such as the Internet.

The skilled person will understand that the term ‘LLM’ refers broadly to the class of generative AI systems capable of processing and generating text in a manner that resembles human language output. While these systems often employ machine learning techniques, specifically neural networks, the term ‘LLM’ does not restrict them to any particular methodology for understanding context or generating responses. LLMs may exhibit a range of architectures and sizes, and can be trained using various methods. The scope of ‘LLM’ is intended to encompass all generative systems that can achieve these functions, without limiting them to any specific architecture, model, or training approach.

As the skilled person will understand, systems for implementing the techniques described above can be implemented using any suitable hardware arrangement including workstations, servers, mobile devices, or embedded systems. This also includes specialized AI hardware like Graphics Processing Units (GPUs), Tensor Processing Units (TPUs), Field Programmable Gate Arrays (FPGAs), Application-Specific Integrated Circuits (ASICs), or other similar hardware suitable for machine learning tasks.

Furthermore, as the skilled person will understand, systems for implementing the techniques described above can be implemented using any suitable programming languages, such as Python, Java, C++, or others, and any suitable AI libraries like TensorFlow, PyTorch, or others. They can be executed as standalone applications, web-based applications, mobile applications, or as parts of larger software systems, or any other suitable deployment methods. The systems can also be containerised for deployment in diverse settings using technologies like Docker, Kubernetes, or similar technologies. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A computer implemented method of generating validated prompt-templates for generating prompts for instructing large language models (LLMs) to perform specific tasks, said method comprising the steps of:
generating an initial prompt instructing an LLM to produce a plurality of candidate prompt-templates for generating test prompts, said initial prompt defining:
an input data type to be included with a prompt generated using a candidate prompt-template, and
output data to be produced by an LLM that has processed a prompt generated using a candidate prompt-template;
passing the initial prompt through an LLM to generate a plurality of candidate prompt-templates;
generating a plurality of test prompts, each test prompt constructed from one of the candidate prompt-templates using input data from a set of pre-labelled input data comprising a plurality of items of input data and corresponding labels,
passing each test prompt through a further LLM to generate an output;
assessing the output data produced by each test prompt with respect to the corresponding label associated with input data with which the test prompt was passed through the further LLM, and
selecting, based on the assessing, one or more of the candidate-prompt-templates for subsequent generation of prompts.

2. A computer implemented method according to claim 1, wherein the output data defined in the initial prompt comprises property data associated with a property of the input data defined in the initial prompt.

3. A computer implemented method according to claim 2, wherein the initial prompt further defines a constraint instruction to be applied by each test prompt which constrains the generated property data generated by each test prompt.

4. A computer implemented method according to claim 3, wherein the constraint instruction specifies a plurality of predetermined properties of which the output data must comprise one.

5. A computer implemented method according to claim 2, wherein the property is one of a qualitative property of the input data or a quantitative property of the input data.

6. A computer implemented method according to claim 1, wherein the input data type defined by the initial prompt is text data.

7. A computer implemented method according to claim 6, wherein the input data type defined by the initial prompt is unstructured text data from a received message.

8. A computer implemented method according to claim 2, wherein each label associated with each item of pre-labelled data specifies property data associated with a property of the item of pre-labelled data.

9. A computer implemented method according to claim 8, wherein the property data specified by each label associated with each item of pre-labelled data specifies one of a plurality of predetermined properties.

10. A computer implemented method according to claim 1, further comprising generating the set of pre-labelled input data by:
retrieving labelled data samples from a labelled data samples data store;
retrieving unlabelled data from an unlabelled-data data store;
labelling the unlabelled data using an AI process guided by the labelled data,
generating labelled data, and
storing the labelled data as pre-labelled input data for use in generating the test prompts.

11. A computer implemented method according to claim 10, wherein the AI process is one of a semi-supervised learning process, an active learning process or a clustering process.

12. A system for generating validated prompt-templates for generating prompts for instructing large language models (LLMs) to perform specific tasks, said system comprising a prompt-template generation instruction module configured to generate an initial prompt instructing an LLM to produce a plurality of candidate prompt-templates for generating test prompts, said initial prompt defining: an input data type to be included with a prompt generated using a candidate prompt-template, and output data to be produced by an LLM that has processed a prompt generated using a candidate prompt-template, said prompt-template generation instruction module configured to communicate the initial prompt to a first LLM system to generate a plurality of candidate prompt-templates, wherein
said system further comprises a test prompt generation module configured to generate a plurality of test prompts, each test prompt constructed from one of the candidate prompt-templates generated by the prompt-template generation instruction module using input data from a set of pre-labelled input data comprising a plurality of items of input data and corresponding labels, said test prompt generation module configured to communicate each test prompt through a further LLM system to generate an output, and
said system further comprising a prompt-template assessment unit configured to assess the output data produced by each test prompt with respect to the corresponding label associated with input data with which the test prompt was passed through the further LLM, and select, based on the assessing, one or more of the candidate-prompt-templates for subsequent generation of prompts.

13. A system according to claim 12, further comprising an AI labelling unit configured to:
retrieve labelled data samples from a labelled data samples data store, and
retrieve unlabelled data from an unlabelled data data store, said AI labelling unit further configured to:
label the unlabelled data using an AI process guided by the labelled data,
generate labelled data, and
forward the label data for storage in a labelled data storage as pre-labelled input data, wherein
the test prompt generation module is configured to obtain the pre-labelled input data for generating the test prompts from the labelled data storage.

14. A system according to claim 13, wherein the AI process is one of a semi-supervised learning process, an active learning process or a clustering process.

15. A system for generating labelled data for use in a system according to claim 12, said system comprising a labelling unit configured to:
retrieve labelled data samples from a labelled data samples data store;
retrieve unlabelled data from an unlabelled-data data store;
label the unlabelled data using an AI process guided by the labelled data, thereby generating labelled data, and
store the labelled data as pre-labelled input data for use in generating test prompts using candidate prompt-templates.

16. A method of generating labelled data for use in a system according to claim 12, said method comprising:
retrieving labelled data samples from a labelled data samples data store;
retrieving unlabelled data from an unlabelled-data data store;
labelling the unlabelled data using an AI process guided by the labelled data, thereby generating labelled data, and
storing the labelled data as pre-labelled input data for use in generating test prompts using candidate prompt-templates.

17. A computer program providing instructions which when implemented on a computing device implements a method according to claim 1.
